(19) United States
(12) Patent Application Publication
(10) Pub. No.: US 2009/0079944 A1
(43) Pub. Date: Mar. 26, 2009

(54) Contactless Operating Device for a Digital Equipment and Method for the Same

(75) Inventor: Jim Chih, Hsinchu (TW)

Correspondence Address: SUTHERLAND ASBILL & BRENNAN LLP, 999 PEACHTREE STREET, N.E., ATLANTA, GA, 30309, US

(73) Assignee: MUSTEK SYSTEMS, INC., Hsinchu (TW)

(21) Appl. No.: 11/860,268

(22) Filed: Sep. 24, 2007

(51) Int. Cl. G03B 21/00; G02B 27/20

(52) U.S. Cl. 353/42

(57) ABSTRACT

A contactless operating device for a digital equipment and method for the same are provided. The contactless operating device includes a computer, a projecting piece, a pointer, and an image-capturing piece. The computer provides a basic picture, and the projecting piece projects the basic picture onto an image zone. Further, the pointer forms a mark onto the image zone for providing a reference picture, and the image-capturing piece connected to the computer captures the reference picture from the image zone. The computer operates the digital device in accordance with a comparison between the basic picture and the reference picture.

### FIELD OF THE INVENTION

The present invention relates to an operating device for a digital equipment and a method for the same, and more particularly to a contactless operating device for a digital equipment and a method for the same.

### BACKGROUND OF THE INVENTION

As the digital technology develops, many varied types of digital equipments are improved and provided, which has a great assistance in information transmission. For example, the projecting device for providing digital images is widely used in commercial and academic venue. In fact, the use of projector and portable computer pairs is almost inevitable in presenting situations.

However, the speaker is not always allowed to operate the portable computer directly when presenting, and one of the possible reasons is because of the restriction from the conference facility. Therefore, the slides transition or other special function control must be implemented by assistances of other persons, which is very inconvenient for the speaker, and will make the presentation discontinuous and fractured. In order to overcome the mentioned deficiencies, how to operate the digital equipments, such as the portable computer or the projector, with a more convenient manner or a contactless manner, has become an important issue in this field.

In order to overcome the drawbacks in the prior art, a contactless operating device for a digital equipment and a method for the same are provided. The particular design in the present invention not only solves the problems described above, but also is easy to be implemented. Thus, the invention has the utility for the industry.

### SUMMARY OF THE INVENTION

In accordance with the present invention, there is provided a contactless operating device for a digital device. The contactless operating device includes a computer, a projecting piece, a pointer, and an image-capturing piece. The computer provides a basic picture, and the projecting piece projects the basic picture onto an image zone. Further, the pointer forms a mark onto the image zone for providing a reference picture, and the image-capturing piece connected to the computer captures the reference picture from the image zone. The computer operates the digital device in accordance with a comparison between the basic picture and the reference picture.

Preferably, the computer is one selected from a group consisting of a personal computer, a notebook computer, a desktop computer, and a pocket personal computer.

Preferably, the projecting piece is one selected from a group consisting of a single beam projector, an LCD projector, a CRT projector, a digital projector, and a DLP projector.

Preferably, the pointer is one selected from a group consisting of a laser point, a finger, a stick, and a cursor of the computer.

Preferably, the image-capturing piece is one selected from a group consisting of a web camera, a dome camera, and a digital camera.

In accordance with another aspect of the invention, there is provided a contactless operating method for a digital device. The contactless operating method includes steps of projecting a basic picture onto an image zone, providing a mark onto the image zone, sequentially capturing at least two reference pictures from the image zone, and operating the digital device in accordance with a first comparison between the basic picture and one of the reference picture, or a second comparison between the at least two reference pictures.

Preferably, the basic pictures and one of the reference pictures are compared to locate the mark.

Preferably, at least two reference pictures are compared to locate the mark.

In accordance with a further aspect of the present invention, a contactless operating devices provided. The contactless operating devices includes a projecting piece and an image-capturing piece. The projecting piece projects a basic picture on an image zone, and the image-capturing piece sequentially captures at least two reference pictures from the image zone, and operates the projecting piece in accordance with a first comparison between the basic picture and one of the reference pictures, or a second comparison between the at least two reference pictures.

Preferably, the contactless operating device further comprises a signal-emitting piece emitting a signal onto the image zone.

Preferably, the emitting piece is a laser point.

Preferably, the contactless operating device further comprises a pointer forming a mark onto the image zone.

Preferably, the pointer is one selected from a finger and a stick.

Preferably, the projecting piece is one selected from a group consisting of a single beam projector, an LCD projector, a CRT projector, a digital projector, and a DLP projector.

Preferably, the image-capturing piece is one selected from a group consisting of a web camera, a dome camera, and a digital camera.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is an illustrating diagram showing a contactless operating device for a digital equipment according to the first preferred embodiment of the present invention;

FIG. 2(a) is an illustrating diagram showing a basic picture according to the first preferred embodiment of the present invention;

FIG. 2(b) is an illustrating diagram showing a reference picture having a light signal thereon according to the first preferred embodiment of the present invention;

FIG. 3(a) is an illustrating diagram showing a basic picture according to the second preferred embodiment of the present invention;

FIG. 3(b) is an illustrating diagram showing a reference picture having a pointer thereon according to the second preferred embodiment of the present invention;

FIG. 4 is an illustrating diagram showing a contactless operating device for a digital equipment according to the third preferred embodiment of the present invention; and

FIG. 5 is an illustrating diagram showing a contactless operating device for a digital equipment according to the fourth preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

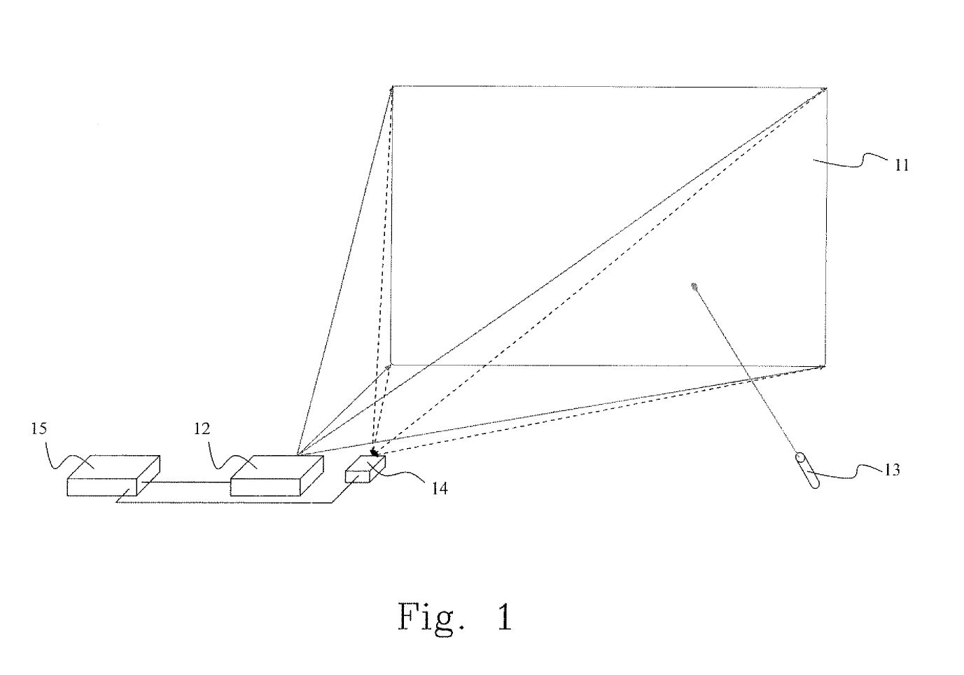

Please refer to FIG. 1, which is an illustrating diagram showing the contactless operating device for a digital equipment according to the first preferred embodiment of the present invention. The contactless operating device showed in FIG. 1 includes an image zone 11, a projecting piece 12, a laser pointer 13, an image-capturing piece 14 and a computer 15. The projecting piece 12 could be a single beam projector, an LCD projector, a CRT projector, a digital projector or a DLP projector. The laser pointer 13 could be a laser pointer, and the image-capturing piece 14 could be a web camera, a dome camera or a digital camera. Finally, the computer 15 could be a personal computer, a notebook computer, a table computer, a pocket personal computer or any other portable computer.

If the computer 15 is a notebook computer, the picture transmitted from the notebook computer to the projecting piece 12 are basic pictures, wherein the basic pictures could be screens of such as Microsoft Windows Operating System or Microsoft PowerPoint. The basic pictures will be projected onto the image zone 11 via the projecting piece 12, and the image-capturing piece 14 will then capture all the images falling within the image zone 11. The images captured by the image-capturing piece 14 are reference pictures, and then the reference pictures will be transmitted from the image-capturing piece 14 to the computer 15. In most cases, a speaker (who is not showed in FIG. 1) usually uses a signal emitted from a laser pointer 13 (such as a laser point) to point and illustrate the context of the basic pictures showed in the image zone 11, which forms the difference between the basic and the reference picture. Consequently, the computer 15 will compare and analyze the difference between the basic and the reference picture, and use the difference as a control signal to operate a digital equipment. Using the difference between pictures to operate the digital equipment is the core feature of the present invention.

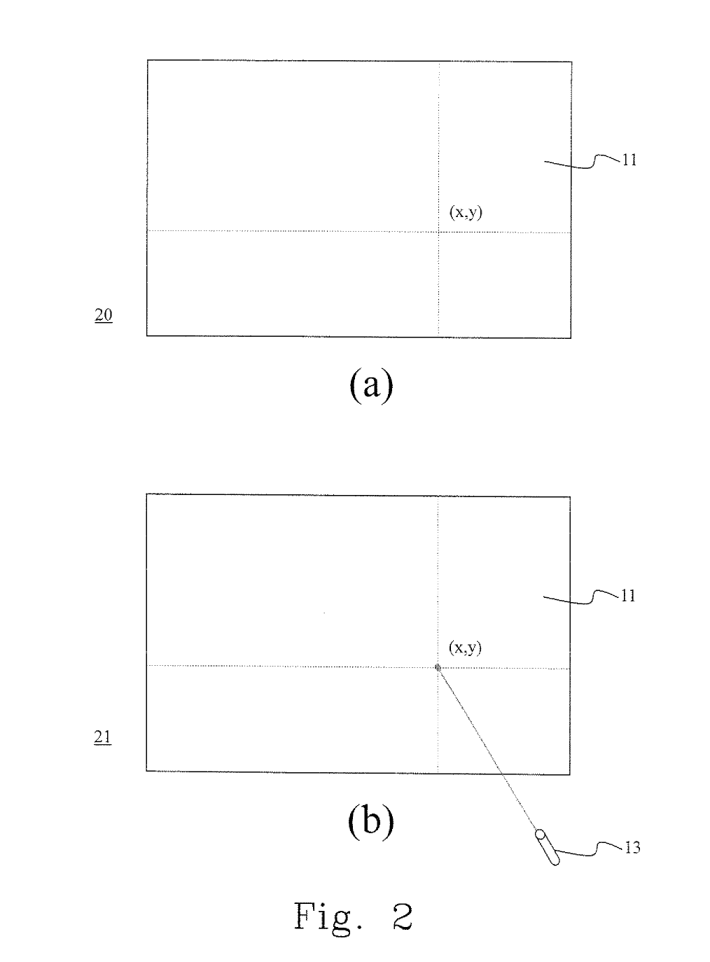

Please refer to FIG. 2(a), which is an illustrating diagram showing a basic picture according to the first preferred embodiment of the present invention, and FIG. 2(b), which is an illustrating diagram showing a reference picture having a light signal thereon according to the first preferred embodiment of the present invention. There includes a basic picture 20, a reference picture 21, at least one image zone 11 and a laser pointer 13 in FIGS. 2(a) and 2(b), wherein the light signal emitted from the laser pointer 13 is located in coordinates (x, y). Therefore, the images in coordinates (x, y) will be different between the basic picture 20 and the reference picture 21, which is caused by the light signal emitted from the laser pointer 13. In point of the computer 15, the operation of the digital equipment is implemented according to the difference between pictures. Nevertheless, in point of the speaker, the operation of the digital equipment is implemented according to the different modes of light signals.

There are several modes of light signals provide in the present invention, which will be further described as follows. Although each light signals mode produces a corresponding mode of images difference, it will not be introduced in detail.

The first mode of light signals is single-click on a specific location of the image zone. The light signal is flashed once on the specific location of the image zone, such as in the “play” icon existing on screens of Windows Media Player or the “open” icon existing on screens of Microsoft Words. The computer 15 could operate the digital equipment according to the comparison between the basic picture 20 and the reference picture 21.

The second mode of light signals is single-click on any other location of the image zone. For example, when presenting by Microsoft PowerPoint, the light signal could be flashed once on any other position of the basic picture 20 formed on the image zone, besides the functional icons, and the computer will perform slides transition to next one.

The third mode of light signals is double-click on the image zone. This double-click mode of light signals will function like double-click mode of mouse on the computer. For example, when a light signal is flashed twice on a specific position of the basic picture 20, such as on a functional icon or a document icon, the computer 15 will continuously compare the basic pictures 20 and the reference pictures 21 to confirm the light signal positions and if the mode of light signals is double-click mode. If the confirmation result is positive, the computer 15 will implement the specific function that the icon shows or open the document accordingly.

As described above, upon the different modes of light signals formed onto the image zone 11, the user could operate the digital equipment with a contact-less manner. It is to be noted that the described modes of light signals are considered to be the preferred embodiments, and the invention needs not be limited to the disclosed embodiments. It is believed that there should be other embodiments existing. However, no matter which kind of light signal modes is applied, the operating principle will not go beyond the above principle disclosed according to the present invention.

It also needs to be noted that there are at least two comparison and analysis methods when comparing and analyzing the differences between the basic picture 20 and the reference picture 21 by the computer 15. The first analysis method is that since the basic picture 20 is provided by the computer 15, the computer 15 could access the basic picture 20 from the intrinsic data directly, and compare them with the reference picture 21 transmitted from the image-capturing piece 14. Consequently, the computer could confirm the differences between the basic picture 20 and the reference picture 21, and operate at least one digital equipment accordingly. The second analysis method is that the computer 15 compares a plurality of reference pictures 21 that are received from the image-capturing piece 14 in sequence, and confirms the difference therebetween to operate at least one digital equipment accordingly. However, no matter which method is applied, the comparison need not be limited between the basic picture 20 and the reference picture 21, or two reference pictures received in sequence. The computer 15 could compare a plurality of basic pictures and a plurality of reference pictures, or compare a plurality of reference pictures received in different times, or compare not in sequence depend on the need in practice.

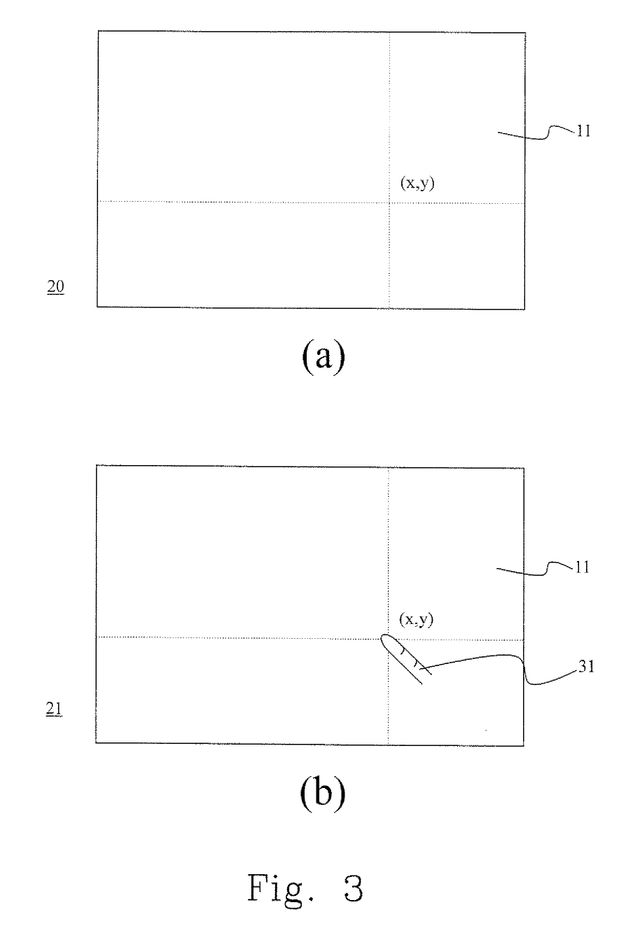

In the situation that the laser pointer 13 is a point having no light signals, the present invention still can work. Please refer to FIG. 3(a), which is an illustrating diagram showing a basic picture according to the second preferred embodiment of the present invention, and FIG. 3(b), which is an illustrating diagram showing a reference picture having a pointer thereon according to the second preferred embodiment of the present invention. There are a basic picture 20, a reference picture 21, an image zone 11 and a pointer 31 showed in FIGS. 3(a) and 3(b), wherein the pointer 31 could be a finger or a stick. In the second preferred embodiment, the pointer 31 is a finger that located on the coordinates (x, y) of the reference picture 21, and hence the respective locations of coordinates (x, y) on the basic picture and the reference picture will be different. The speaker could operate at least one digital equipment according to the specific signal provided by the pointer, and the working principle is the same as what has described above.

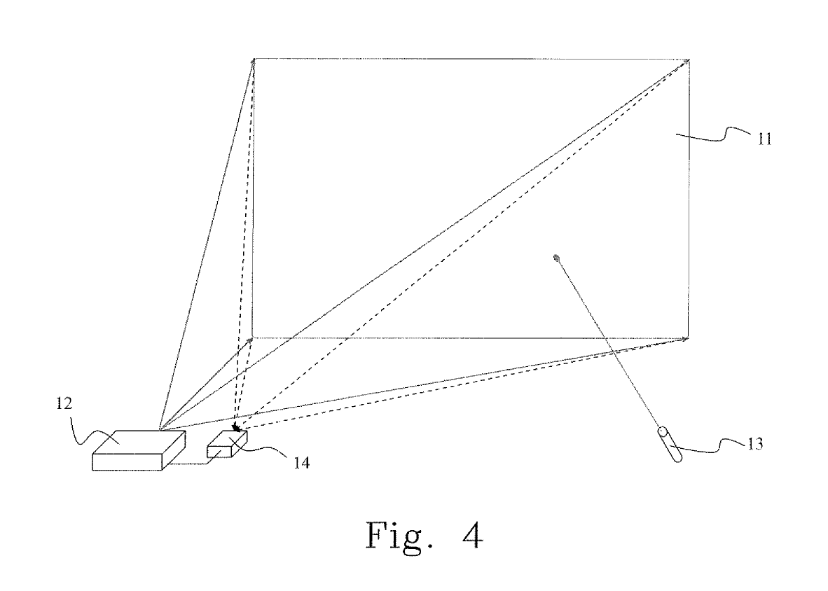

Further, as the multimedia technology develops, the projector that can store presenting data and show slides without further devices has been provided. This is to say, the speaker no longer needs the computer 15 when presenting. Accordingly, a unit having the function of comparing the basic with the reference pictures to confirm the differences therebetween, could be incorporated within the image-capturing piece. The contactless operating method according to the present invention could be implemented only by simple combination of the projecting piece and the image-capturing piece. Please refer to FIG. 4, which is an illustrating diagram showing the contactless operating device for a digital equipment according to the third preferred embodiment of the present invention. There are an image zone 11, a projecting piece 12, a laser pointer 13 and an image-capturing piece 14 showed in FIG. 4, and the projecting piece 12 could be a single beam projector, a LCD projector, a CRT projector, a digital projector or a DLP projector. However, no matter what kind of projecting piece is adapted, the adapted projecting piece could show slides independently without being connected to an additional computer. Moreover, the laser point 13 could be other signal-emitting pieces, and the image-capturing piece 14 could be a web camera, a dome camera or a digital camera. Because the image-capturing piece 14 already has the function of comparing the basic picture 20 with the reference picture 21 in order to confirm the differences therebetween, the speaker could operate the digital equipment with a contactless manner by simply combining the projecting piece 12 and the image-capturing piece 14.

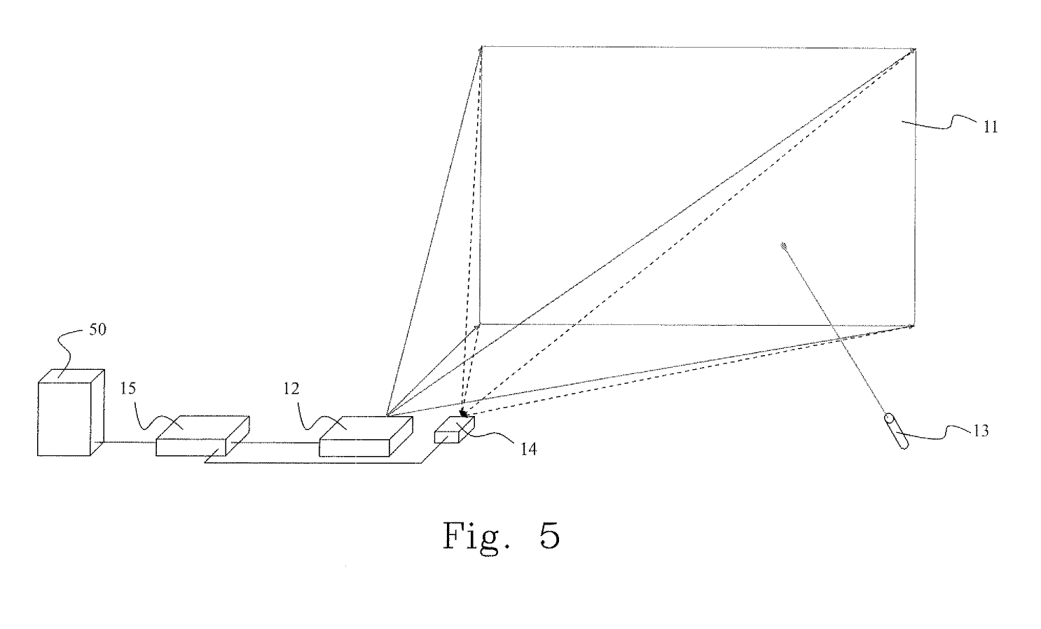

Based on the working principle mentioned above, the following preferred embodiment could be further provided, where the technical scheme provided in the present invention is applied to multimedia equipment. Please refer to FIG. 5, which is an illustrating diagram showing the contactless operating device for a digital equipment according to the fourth preferred embodiment of the present invention. There are an image zone 11, a projecting piece 12, a laser pointer 13, an image-capturing piece 14, a computer 15 and a multimedia equipment 50. The projecting piece 12 could be a single beam projector, a LCD projector, a CRT projector, a digital projector or a DLP projector. The laser pointer 13 could be other signal-emitting piece, and the image-capturing piece 14 could be a web camera, a dome camera or a digital camera. The computer 15 could be a personal computer a notebook computer, a table computer, a pocket personal computer or any other portable computer. The multimedia equipment 50 could be a loudspeaker, a DVD player, a plate television or a large-sized flat screen. The main working principle of the fourth preferred embodiment is the same as that described above, and if necessary, the user even could operate more than one multimedia equipment according to the contactless operating device of the present invention.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A contactless operating device for a digital device, comprising:
a computer providing a basic picture;
a projecting piece projecting the basic picture onto an image zone;
a pointer forming a mark onto the image zone for providing a reference picture; and
an image-capturing piece connected to the computer and capturing the reference picture from the image zone, wherein the computer operates the digital device in accordance with a comparison between the basic picture and the reference picture.

2. A contactless operating device as claimed in claim 1, wherein the computer is one selected from a group consisting of a personal computer, a notebook computer, a desktop computer, and a pocket personal computer.

3. A contactless operating device as claimed in claim 1, wherein the projecting piece is one selected from a group consisting of a single beam projector, an LCD projector, a CRT projector, a digital projector, and a DLP projector.

4. A contactless operating device as claimed in claim 1, the pointer is one selected from a group consisting of a laser point, a finger, a stick, and a cursor of the computer.

5. A contactless operating device as claimed in claim 1, wherein the image-capturing piece is one selected from a group consisting of a web camera, a dome camera, and a digital camera.

6. A contactless operating method for a digital device, comprising steps of:
projecting a basic picture onto an image zone;
providing a mark onto the image zone;
sequentially capturing at least two reference pictures from the image zone; and
operating the digital device in accordance with one of a first comparison between the basic picture and one of the reference picture and a second comparison between the at least two reference pictures.

7. A contactless operating method as claimed in claim 6, wherein the basic pictures and one of the reference pictures are compared to locate the mark.

8. A contactless operating method as claimed in claim 6, wherein at least two reference pictures are compared to locate the mark.

9. A contactless operating device, comprising:
a projecting piece projecting a basic picture on an image zone; and
an image-capturing piece sequentially capturing at least two reference pictures from the image zone, and operating the projecting piece in accordance with one of a first comparison between the basic picture and one of the reference pictures and a second comparison between the at least two reference pictures.

10. A contactless operating device as claimed in claim 9, further comprising a signal-emitting piece emitting a signal onto the image zone.

11. A contactless operating device as claimed in claim 10, wherein the emitting piece is a laser point.

12. A contactless operating device as claimed in claim 9, further comprising a pointer forming a mark onto the image zone.

13. A contactless operating device as claimed in claim 12, wherein the pointer is one selected from a finger and a stick.

14. A contactless operating device as claimed in claim 9, wherein the projecting piece is one selected from a group consisting of a single beam projector, an LCD projector, a CRT projector, a digital projector, and a DLP projector.

15. A contactless operating device as claimed in claim 9, wherein the image-capturing piece is one selected from a group consisting of a web camera, a dome camera, and a digital camera.
